(19) United States
(12) Patent Application Publication
(10) Pub. No.: US 2009/0006135 A1
(43) Pub. Date: Jan. 1, 2009

(54) Accelerated Payments for Health Care Plans

(75) Inventors: Mark KECK, New York, NY (US); Sarah Harrison, London (GB); Ahana Kalappa, New York, NY (US); Sunil Sachdev, New Rochelle, NY (US); Margaret A. Miller, Land O'Lakes, FL (US); Sachin Joshi, New York, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related services Company, Inc., New York, NY (US)

(21) Appl. No.: 11/768,708

(22) Filed: Jun. 26, 2007

(51) Int. Cl. G06Q 40/00

(52) U.S. Cl. 705/4; 705/40

(57) ABSTRACT

A method for accelerating a payment to a merchant for a healthcare related claim. The method comprises submitting a healthcare related claim for payment from the merchant to a payer; determining at the payer whether the member is eligible for services covered as a part of his or her healthcare plan. If the member is determined to be eligible for payment of claim(s) submitted, then a financial institution is notified of an estimated amount of liability for the claim. At least a portion of the estimated amount of liability for the claim is paid to the merchant by the financial institution. The financial institution thereafter receives a reimbursement/payment from a healthcare finding source for the adjudicated amount of liability for the claim. Once the claim is adjudicated, a healthcare management system reconciles with the merchant for any under or over payment.

### CROSS REFERENCE TO OTHER APPLICATIONS

The embodiments described herein can be combined with a payment system described in U.S. patent application Ser. No. 11/275,403, filed Dec. 29, 2005, entitled FACILITATING PAYMENTS TO HEALTH CARE PROVIDERS, and commonly assigned with the present invention. The disclosure of the '403 application is incorporated herein by reference in its entirety as though set forth in full below.

### BACKGROUND OF THE INVENTION

1. Field of the Invention

The present invention generally relates to healthcare payment systems and, more particularly, to a system and a method for accelerating payments to providers of healthcare related services.

2. Related Art

Fundamental changes are occurring in the healthcare industry with respect to expenditures by consumers. Healthcare expenditures in the U.S. are expected to increase from approximately $558B in 1988 to approximately $3,361B by 2013. It is projected that consumers will pay a larger share of those expenditures, from approximately 14% in 2001 to an expected 19% in 2010.

Section 125 of the United States Internal Revenue Code offers tax savings to employees for medical, dependent care and childcare expenses. Likewise, Section 132 of the United States Internal Revenue Code offers employees tax savings for work-related parking and transportation expenses. For example, employees may be entitled to tax benefits if the employees withhold a portion of their payroll to pay for medical, dependent care, childcare, work-related parking expenses and/or work-related transportation expenses. In other words, the employees' payroll is taxed on the amount left after the withheld portion is subtracted from the payroll amount and the withheld portion is placed into a flexible spending account.

How consumers pay for healthcare expenditures also is changing. Presently, less than 20% of consumer healthcare payments is through the use of “plastic,” which includes debit cards, charge cards, and credit cards. This percentage is expected to grow by over 10% in five years to approximately 30% by 2010.

Another fundamental change that is expected to occur in the healthcare industry is the increase in the use of high deductible healthcare plans (“HDHPs”), which place a higher burden of co-payment on plan members.

The shift towards HDHPs, while providing certain benefits to employers and/or employees, also entails significant administrative costs. These costs include, for example, the delays associated with payments to healthcare providers. Providers of healthcare goods/services often encounter significant delays in receiving payment from health insurance companies, or comparable payers, due to the amount of time necessary to adjudicate claims and to determine the respective payment responsibilities of the insurers and the insured. There are also delays associated with a plan member paying his or her part to the provider. Such delays are expected to increase further as new HDHPs are introduced. For example, in a typical scenario, the entire payment process described above can take as long as 30-60 days under normal circumstances.

Given the foregoing, one thing that is needed is a system and a method for expediting the process for paying providers.

### BRIEF SUMMARY OF THE INVENTION

In one example, the present invention meets the above-identified needs by providing a method for accelerating a payment to a merchant for a healthcare related claim. The method comprises submitting a healthcare related claim for payment from the merchant to a payer and determining at the payer whether the member is eligible for healthcare plan payment. If the claim is determined to be eligible for payment by the insurer, then a financial institution is notified of an estimated amount of liability for the claim. At least a portion of the estimated amount of liability for the claim is paid to the merchant by the financial institution. The financial institution thereafter receives a reimbursement from a healthcare funding source for the actual amount of liability for the claim. Once the claim is adjudicated, a healthcare management system reconciles with the merchant for any under or over-payment.

### BRIEF DESCRIPTION OF THE DRAWINGS/FIGURES

The features and advantages of the present invention will become more apparent from the description set forth below when taken in conjunction with the attached drawing.

FIG. 1 is a block diagram illustrating major components of an accelerated payment system according to an exemplary embodiment of the invention.

FIG. 2 shows a flow chart of a scenario where a third party claims negotiator is employed to negotiate claims presented that are out of network.

FIG. 3 shows a flow chart of a scenario where a merchant receives accelerated payment according to total liability for negotiated claims.

FIG. 4 shows a flow chart of a scenario where a merchant receives accelerated payment according to payer liability for pre-adjudicated claims.

FIG. 5 shows a flow chart of a scenario where a merchant receives accelerated payment according to total liability for pre-adjudicated claims.

FIG. 6 shows a flow chart of a scenario where a merchant receives accelerated payment according to member liability for post-adjudicated claims.

FIG. 7 shows a flow chart of a scenario where a payer and a healthcare management system (HMS) communicate directly with each other for acceleration of payments.

### DETAILED DESCRIPTION OF EMBODIMENTS OF THE INVENTION

The detailed description of exemplary embodiments of the invention herein makes reference to the accompanying drawings and figures, which show the exemplary embodiments by way of illustration. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not by way of limitation. For example, the steps recited in any of the method or process descriptions may be executed in any order and arc not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary Functional relationships and/or physical couplings between the various elements. It should be noted that many alternative or additional functional relationships or physical connections may be present in a practical system.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may he separated into multiple webpages and/or windows but have been combined for simplicity. The computer systems, computer products, data processing apparatus and computer program instructions may carry out the functions described herein in a secure communications mode, for example, by using encryption technologies well known to those skilled in the art.

### Terminology

The term “merchant” or “provider” as used herein shall mean any person, entity, distributor system, software, and/or hardware that is a provider, broker, and/or any other entity in the distribution chain of goods or services. For example, a merchant may be a credit card issuer, a hotel chain, an airline, a grocery store, a retail store, a travel agency, a service provider, including, but not limited to, a medical service provider, an online merchant, or the like.

As used herein, an “item” may be one or more of information, good and/or service capable of being exchanged between entities. In addition, an “item identifier” may include, for example, one or more of a universal product code (UPC), a stockkeeping unit (SKU), a serial number, a reference number, a category number, a service type indicator, a requester name, a price, a description and/or any other information capable of identifying an item. Similarly, “items purchased”, as used herein, may include healthcare products, such as, but not limited to medicines/prescription drug, medical electronics devices or services received by a patient from a service provider.

A “transaction account” as used herein refers to an account associated with an open account card or a closed account card system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use with a particular merchant, a particular chain of merchants or a collection of affiliated merchants. One example of a closed card is a card that may only be accepted at a clothing retailer.

The term “transaction instrument” as used herein may include any type of open or closed charge card, credit card, debit card, FSA card, stored value card, an RFID chip based card or token, and the like. For convenience, a transaction instrument may be referred to as a “card.”

An “account,” “account number” or “account code” , as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder, radio frequency card or payment statement).

As used herein, the terms “employer”, “end user”, “consumer”, “customer”, “cardmember”, “business” or “merchant” may be used interchangeably with each other, and each shall mean any person, entity, machine, hardware, software or business.

As used herein, “point of sale device” may be any software and/or hardware suitably configured to facilitate a purchase. It may include any means or manner of communicating with one or more host computers for the purpose of making requests for payment or payment authorization. Such means may include, but are not limited to, telephonic means, card readers, computer terminals connected directly to the host computer(s) or indirectly, via e.g., the Internet, or any other means of communication known to persons skilled in the relevant arts.

As used herein, a “payer” may be an insurance company or other healthcare provider that administers one or more healthcare related plans.

As used herein, “transmit” may include sending electronic data from one system component to another over a network connection.

Additionally, as used herein, “data” may include encompassing information such as commands, queries, files, data for storage, and the like in digital or any other form.

“Transaction data” may include, for example, one or more of the amount of purchase, at least one payment instrument account number, at least one payment account number, at least one item identifier for each item being purchased, loyalty information, demographic information and/or any other data helpful in processing a transaction.

“Switch” may include, for example, a clearing-house, and/or a system or a method for routing data electronically or via paper, generally between providers and payers, checking for errors, formatting or editing and correcting errors (also referred to as “scrubbing”).

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

### Overview

The invention is a computer-implemented method and system to facilitate payment to a merchant for a healthcare related claim. The merchant submits a healthcare related claim for payment to a claim adjudicator. The adjudicator determines whether a member with whom the claim is associated, is eligible for payment under a healthcare plan. If the member is determined to be eligible for payment, then the adjudicator notifies a financial institution directly or through a third party, such as a negotiator, to pay the claim. The financial institution then pays at least a portion of the claim amount to the merchant. The financial institution thereafter receives a reimbursement from a healthcare funding source for the actual amount of the healthcare related claim

Further details of embodiments of this invention are described below.

### Embodiments

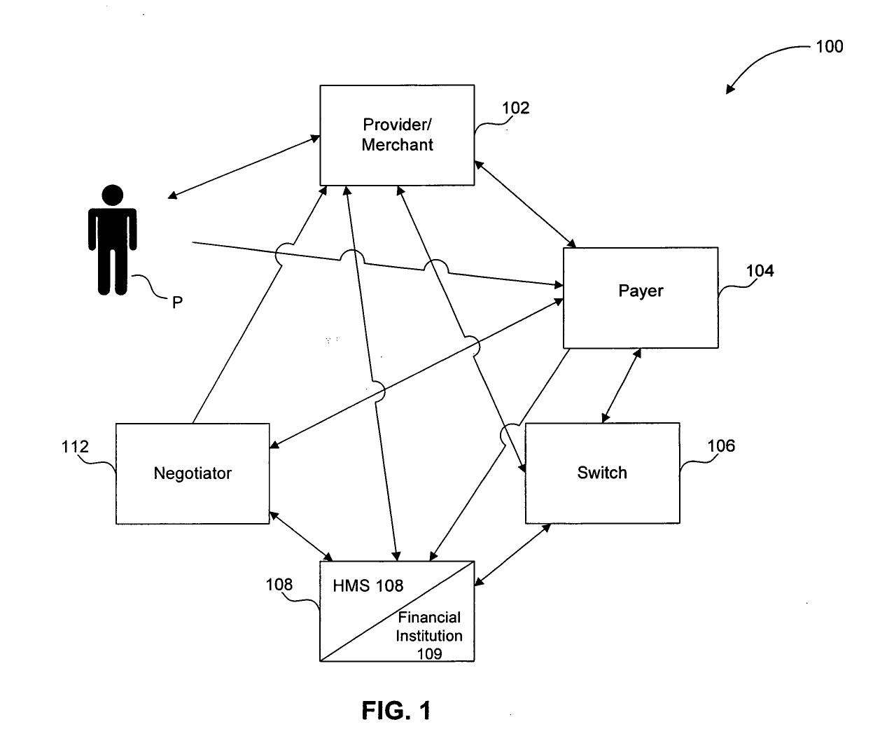

FIG. 1 is a block diagram illustrating major components of an accelerated payment system according to an exemplary embodiment of the present invention. The system involves a merchant 102, typically a healthcare provider, such as a physician, hospital, pharmacy, etc. The system may also involve one or more of a claim adjudicator or payer 104, such as a health insurance company, or the like, a claim processor or Switch 106, a Healthcare Management System (HMS) 108, a financial institution 109, associated with HMS 108 and a third party negotiator 112.

Switch 106 may or may not be part of a larger Practice Management System (PMS). The PMS is typically a program that resides on the provider's computer or as a web based service. A PMS typically can perform a variety of tasks, such as scheduling appointments, perform eligibility verification for claims made, claims processing, etc. One such function performed by the PMS is to transfer claim data, including customer identification information, services performed, eligibility information, verification information, and the like, from provider 102 to payer 104. Switch 106 will process (or “scrub”) a claim from provider/merchant 102 to ensure that all required information has been presented so that the claim will not be immediately rejected by payer 104. Once the claim has been scrubbed, the claim is sent to payer 104 on behalf of provider 102. The Switch 106 will then remit to provider 102 an acknowledgement that the claim has been submitted to payer 104 for processing. Provider 102 can then monitor the status of the claim to determine whether it is being reviewed, whether it has been denied, or whether it has been approved for payment.

There are two types of payment processing procedures that may be followed. In one type of processing a patient or a member may be a part of a healthcare plan or network through the plan or network with which the merchant is not associated (called “out of network”). The other type of processing takes place when the patient or the member and merchants are associated with the same healthcare plan (called “in network”).

### Out of Network

In an out of network situation, a patient P and a merchant 102 are not associated with the same healthcare plan. Merchant 102 submits a claim for an item, such as services or goods, or a patient P submits a claim to payer 104. Additionally and alternatively, both merchant 102 and member P may submit a claim to payer 104. Claims are submitted either in real time, as the transaction occurs, or periodically in a batch mode, such as once a day, for example. Payer 104 adjudicates the claim, that is, payer 104 determines whether the patient with whom the claim is associated is eligible for coverage by payer 104. Payer 104 also determines patient liability for all or a portion of the claim. Payer 104 can then submit the adjudicated claim to a negotiator 112. In conventional systems, this process can take a considerable amount of time, for example up to about 30 days or so.

Payer 104 may submit adjudicated claim or payment information to negotiator 112, which negotiates with provider 102 for an amount corresponding to the claim. Post negotiation, a financial institution associated with HMS 108 may receive payments associated with the claim, per the patient's healthcare plan. In addition or alternatively, the financial institution transmits payment of the adjudicated claim to merchant 102 and negotiator 112 may send payment detail information to merchant 102.

### In Network

In this mode of operation, patient P (also referred to as member P) and merchant 102 are both associated with the same healthcare plan. In this scenario, merchant 102 submits a claim to payer 104 or a Switch 106. Where the merchant 102 is associated with the same healthcare plan, payment conditions have been agreed upon. Therefore, it is not necessary to use a negotiator for in network transactions.

In order to cut down on the processing time in embodiments of the present invention, merchant 102 submits an eligibility verification request to Switch 106 and requests member eligibility. Switch 106 sends an estimate of payer and member liability information back to merchant 102 and sends an estimate of payment amount to HMS 108, per patient P's healthcare plan. HMS 108 then sends payment to merchant 102 based on the estimated claim payment amount. If merchant 102 has an account with a financial institution 109 associated with HMS 108, the account is immediately credited with the payment.

Typically, the estimated payment sent to merchant 102 at this stage will be a percentage of the estimated claim payment amount provided by Switch 106. For example, HMS 108 may allow payment of 80% of the estimated claim payment amount to merchant 102. This process can be accomplished in a matter of days, rather than the weeks it previously took to process payment.

Since this is only an estimate, it is necessary for payer 104 to determine the total amount of the claim payment after reviewing the healthcare plan terms and the services performed by merchant 102. Once payer 104 finalizes adjudication of the claim, payer 104 transmits this information to Switch 106. Switch 106 then transmits the actual member and payer liability information to HMS 108 which will then reconcile with merchant 102 and settle with merchant 102 for the difference between the accelerated payment and the actual allowed amount. Often, HMS 108 will retain a small percentage of the total claim payment as a fee for the services it performs in transmitting payments to merchant 102. HMS 108 then collects member P and payer 104 liability from the respective parties on behalf of financial institution 109.

The above described scenarios can be further explained by way of examples below. However, these examples are presented for illustrative purposes only and are not meant to be limiting. After reading this disclosure, one of ordinary skill in the art can contemplate various permutations of the examples below to result in other examples that capture various embodiments of the present invention.

### Negotiated Claims-Exemplary Scenarios

1. Accelerated Payer Liability for Negotiated Claims

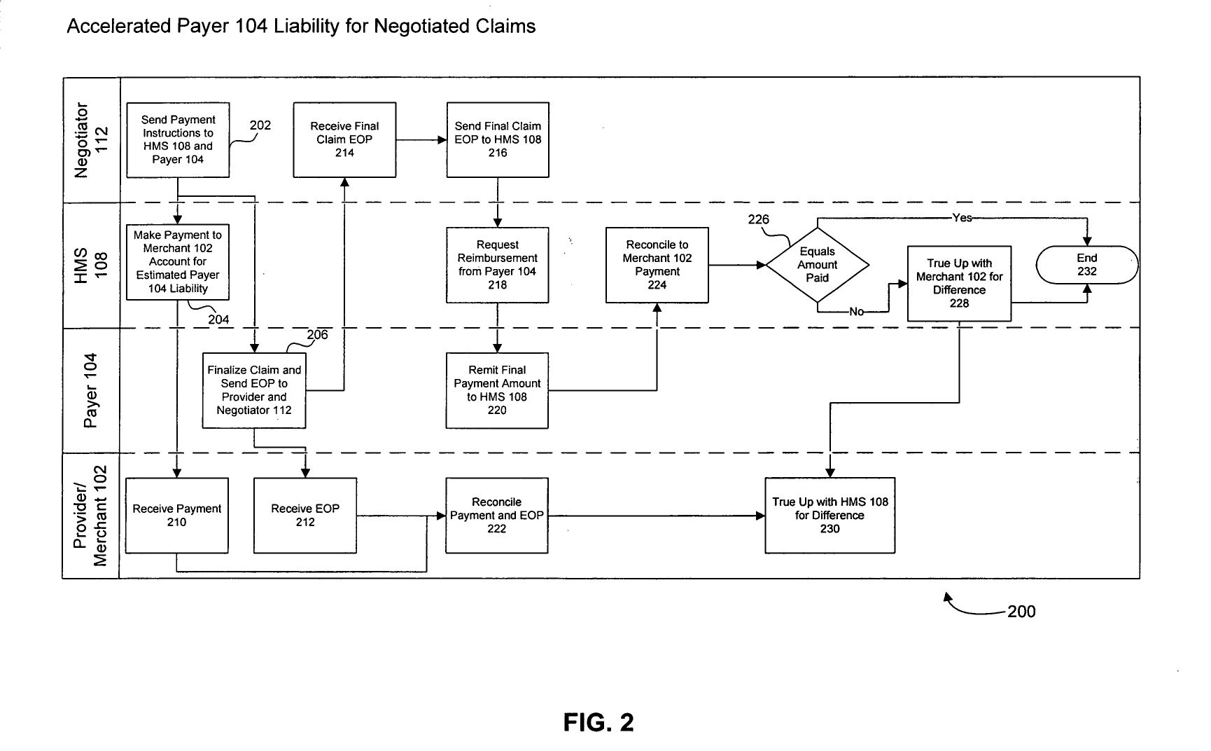

FIG. 2 shows a flow chart of a scenario where a third party claims negotiator 112 is employed to negotiate claims presented that are out of network. In this case, negotiator 112 will have negotiated a claim amount with merchant 102 prior to step 202. At that time, negotiator 112 will ask merchant 102 if they would like to have an accelerated claims payment; typically, this may require that merchant 102 accept (or agree to) a discount from the negotiated claim amount. At step 202, negotiator 112 sends claim payment instructions to both HMS 108 and payer 104. If merchant 102 accepts accelerated payment, HMS 108 will instruct financial institution 109 to make payment to merchant 102 at step 204. Similar to the process described above for accelerated payment, HMS 108 may instruct financial institution 109 to pay merchant 102 a percentage of the total claim amount pending a final determination of the actual claim amount by payer 104. In general, negotiator 112 bases its negotiations on the history or past data associated with a particular provider 102 on a claim by claim basis.

It should be noted that throughout this description, HMS 108 will typically be associated with financial institution 109. Payments are made by and/or to financial institution 109 according to instructions from HMS 108, where appropriate. In general, references throughout Lo payments made by or to HMS 108 are in fact made by or to financial institution 109 in accordance with instructions from HMS 108. In some embodiments, financial institution 109 assumes the additional role of HMS 108 and a separate HMS 108 can be eliminated.

Merchant 102 receives payment from HMS 108 at step 210. At step 206, payer 104 finalizes the claim and sends an Explanation of Payment (EOP) to negotiator 112 at step 214 and to merchant 102 at step 212. Merchant 102 can then reconcile the BOP with the partial payment from HMS 108 at step 222.

Negotiator 112 receives an EOP from payer 104 at step 214 and sends a final claim to HMS 108 at step 216. At step 218, HMS 108 requests reimbursement for the final claim amount from payer 104. At step 220, payer 104 transmits the final payment amount to HMS 108. EMS 108 receives payment from payer 104 and at step 224 reconciles the claim amount with the amount previously paid to merchant 102 at step 204. If, at step 226, the amount previously paid to merchant 102 equals the final claim payment, the process ends at step 232. If the amount paid to merchant 102 by HMS 108, is not equal to the final claim payment, then at step 228, HMS 108 settles with merchant 102 for the difference. If HMS 108 owes merchant 102 an additional amount the balance is deposited in merchant 102's account with a financial institution associated with HMS 108 at step 230. If HMS 108 had overpaid merchant 102, then HMS 108 withdraws the excess payment from merchant 102's account.

2. Accelerated Total Liability for Negotiated Claims

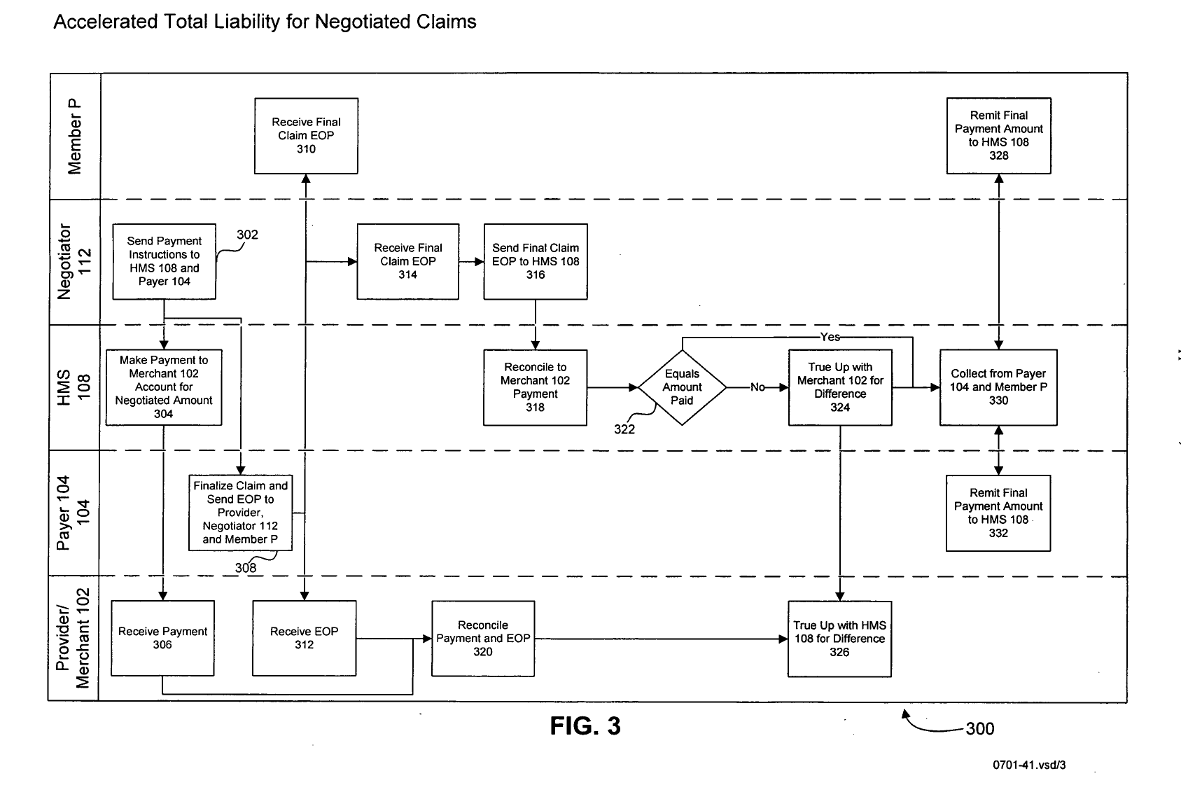

FIG. 3 shows the overall picture in terms of total liability for negotiated claims. Process 300 described in FIG. 3 is similar to process 200 described in FIG. 2 with additional liability in the part of member P. Member P is someone with whom payer 104 has a relationship. Similar to process 200, a third party claims negotiator 112 negotiates with merchant 102 for an accelerated claims payment for the trade-off of a discount on the amount corresponding to the claims. Negotiator 112 then sends payment instructions to HMS 108 (as shown in step 302). HMS 108 makes a payment to merchant 102 for a negotiated amount, as shown in step 304. Merchant 102 receives a negotiated payment amount in step 306. Once the claims are finalized in step 308, member P and merchant 102 will receive the final claim and an EOP in steps 310 and 312, respectively. In parallel, third party negotiator 112 will also receive a final claim EOP (step 314) and send a final claim EOP to HMS 108, in step 316. These communications of EOP information will contain information about how much each of member P, merchant 102 or negotiator 112 needs to pay.

On receiving a final claim EOP in step 318, HMS 108 initiates a reconciliation process with merchant 102. Such a reconciliation process involves checking if equal amounts were paid or not, as shown in step 322. If not, as may happen when a claim has not been fully adjudicated, a true up process with the merchant is performed as shown by steps 324 and 326, similar to the true up process described in FIG. 2. Since HMS 108 has a relationship with merchant 102, depending on the amount of the claim, the true up could result in a debit or a credit to merchant 102's account with EMS 108. However, unlike in FIG. 2 where the process ends after the true up step, HMS 108 collects the remaining balance amounts from payer 104 and member P if the amounts are equal (shown in step 330). In steps 332 and 328, payer 104 and member P, respectively, remit final payment to HMS 108.

### Pre-Adjudicated Claims—Exemplary Scenarios

1. Accelerated Payer Liability for Pre-Adjudicated Claims

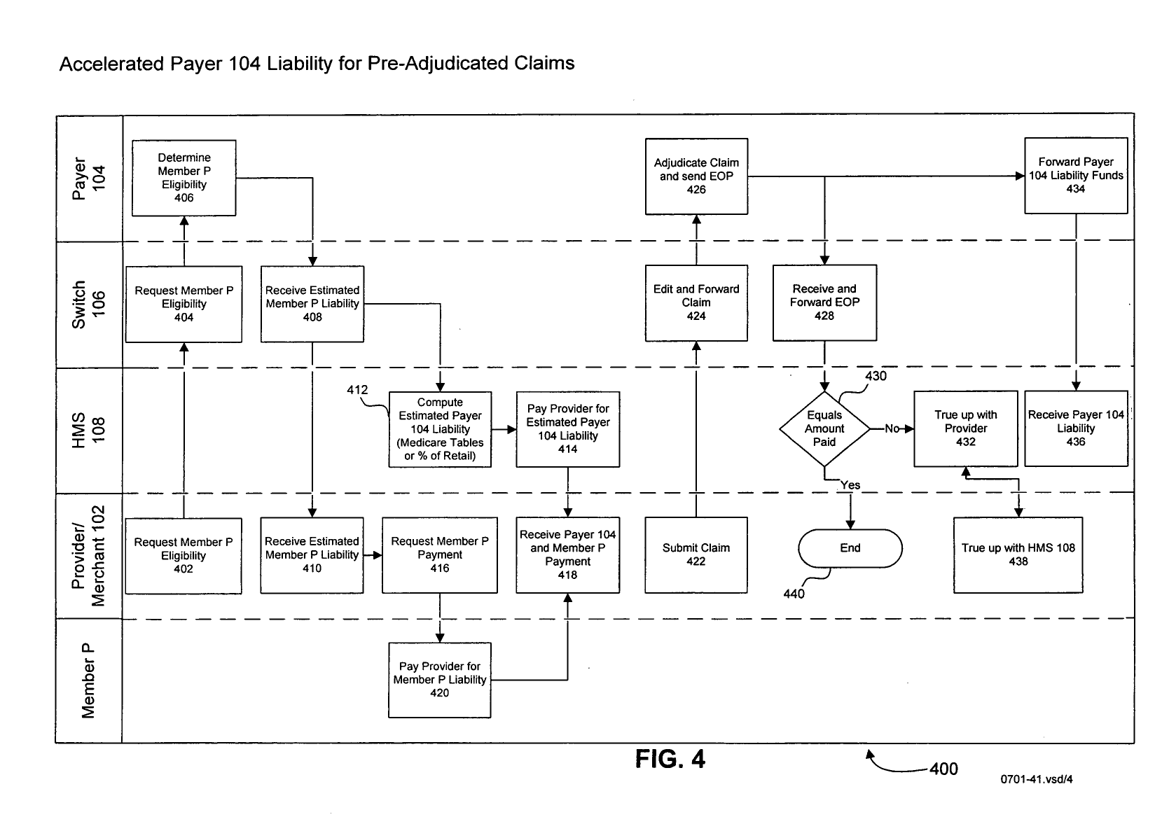

In place of a third party negotiator 112, for example in the case of an in-network transaction, a Switch 106 can also be used in determining member eligibility and forwarding claims information. Such a Switch 106 can be connected to or be a part of, for example a PMS or a web-portal at the offices of a provider 102. Queries related to eligibility of member P can be triggered by a card swipe or a manual software interface query, or otherwise. FIG. 4 illustrates a process 400 in which HMS 108 has a relationship with payer 104. Member P may or may not be a member affiliated with or having a relationship with HMS 108 or a financial institution associated with HMS 108. For example, member P may be a medical patient who needs healthcare services.

Process 400 starts at step 402 with provider 102 requesting member eligibility and/or a liability estimate from payer 104. Switch 106 functions as an interface for transmittal of such a request, as shown in step 404. In step 406, payer 104 determines member P's eligibility for any plan benefits. Member P's eligibility information is passed down to provider 102 via Switch 106, as shown in step 408. In parallel, EMS 108 receives estimated payer liability from Switch 106 in step 412. Further, in step 412, HMS 108 then computes the estimated liability of payer 104. Such a computation can be on the basis of existing Medicare tables or data associated with percentage of retail for every claim submitted. Based on such computations, HMS 108 will pay provider 102 at least for a partial amount if not the full computed amount, for estimated liability of payer 104, as shown in step 414.

Provider 102 can request payment from member P, as shown in step 416. Once member P has paid provider 102 for amounts corresponding to member P's liability, as shown in step 420, provider 102 has total information of payer 104's liability and member P's liability. This is shown in step 418. Provider 102 can then formulate a claims statement for submission, as shown in step 422. Such a claim is then passed on to switch 106 in step 424, either in batch mode or on a case by case basis, depending upon specific needs. Switch 106 then forwards the claims information to payer 104 in step 426. In step 426, payer 104 then adjudicates the claim and sends an EOP back to switch 106. Switch 106 receives the EOP and forwards it to HMS 108 as shown in step 428. In step 430, HMS 108 checks if provider 102 received the correct claim amount as computed in step 412. If yes, process 400 ends in step 440. If not, HMS 108 trues up with provider 102 for the difference, as shown by steps 432 and 438.

Payer 104 will forward liability funds to HMS 108, as shown in step 434. In such a case, HMS 108 directly receives payer 104's liability and ends process 400, as shown in step 436.

2. Accelerated Total Liability for Pre-Adjudicated Claims

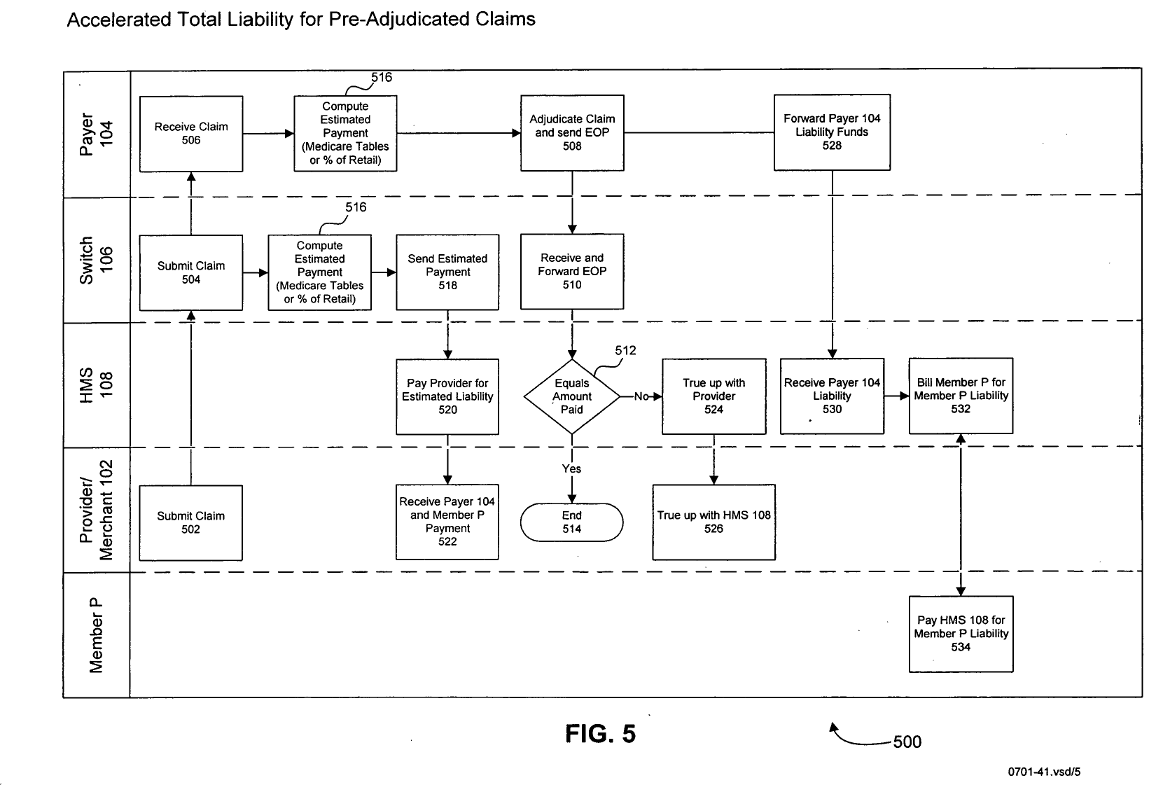

FIG. 5 shows a process 500 for making payments to provider 102 by computing total amounts for payer 104 and member P. Process 500 starts with provider 102 submitting a claim in step 502 to a Switch 106. Switch 106 receives the claim in step 504 and forwards it to payer 104.

Provider 102 receives member P and payer 104 payment via HMS 108, as shown in step 522. In such a scenario, Switch 106 is used to compute an estimated payment amount based on percentages of retail, Medicare tables, historical information or otherwise, as shown in step 516. Switch 106 may then send the estimate of payment to HMS 108 in step 518 based on various procedure codes for services received by member P from provider 102. In step 520, HMS 520 pays provider 102. Provider 102 receives this payment in step 522.

After the merchant 102 has received payer 104 and member P's payment in step 522 and on receiving the claim in step 506, payer 104 then adjudicates the claim. As shown in step 508, payer 104 sends an EOP to Switch 106. Switch 106 receives the EOP from payer 104 and forwards it to HMS 108 in step 510. In step 512, HMS 108 verifies whether the EOP amount equals the accelerated payment amount or not. If yes, process 500 is ended in step 514. If not, HMS 108 and provider 102 true up with each other for the balance amount, as shown in steps 524 and 526. After adjudicating claims in step 508, payer 104 may send payer liability funds to HMS 108, as shown in steps 528 and 530. HMS 108 may bill member P for member liability corresponding to one or more claims, as shown in step 532. Member P may then pay HMS 108 for member liability, as shown in step 534.

### Post-Adjudicated Claims-Exemplary Scenario

1. Accelerated Member Liability for Post-Adjudicated Claims

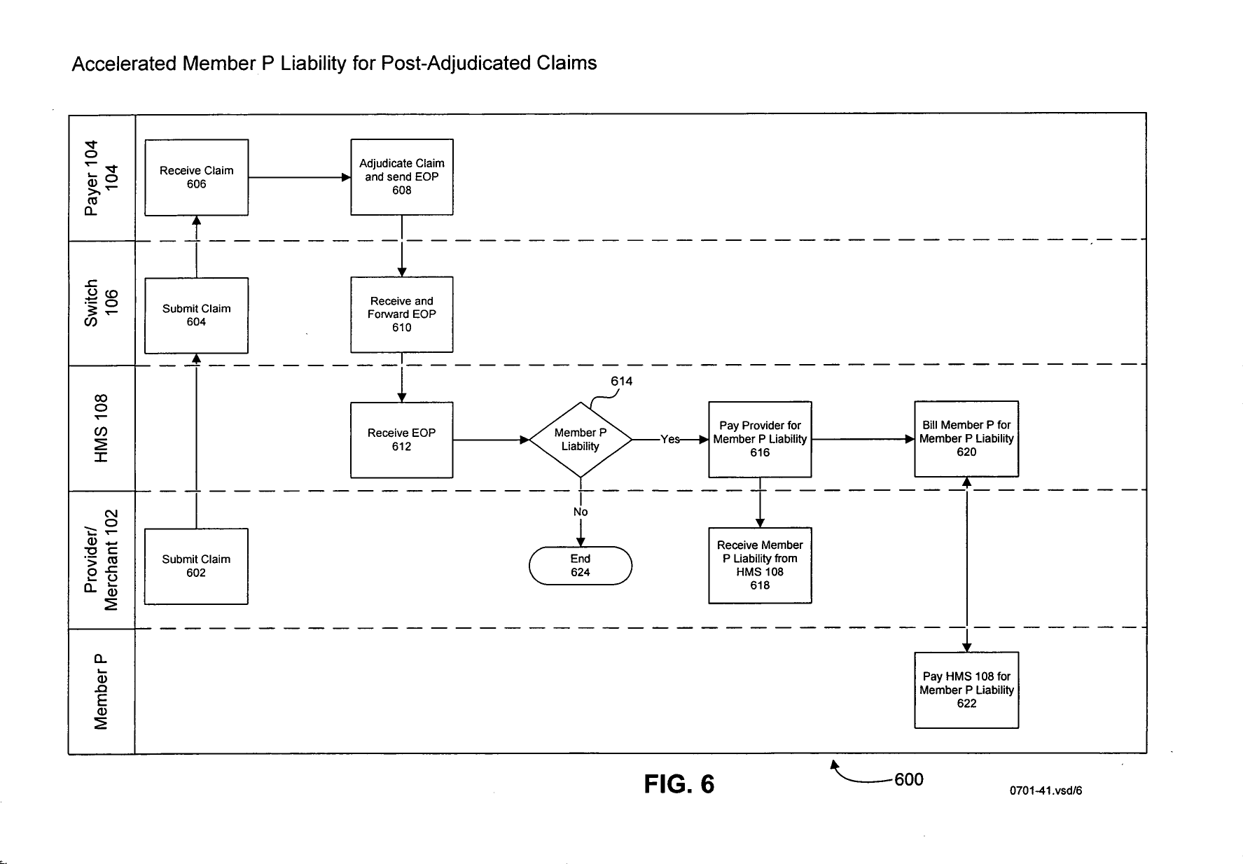

FIG. 6 shows a process 600 to cover member P's liability in an accelerated payment scenario. Process 600 relies upon post-adjudicated claims status where provider 102 submits claims in step 602. Switch 106 “scrubs” these claims in step 604 and transfers them to payer 104. Payer 104 receives these claims in step 606 and adjudicates the claims in step 608. Further, in step 608, payer 104 sends an EOP back to switch 106. Switch 106 forwards this EOP to HMS 108 in step 610. HMS 108 receives the EOP in step 612. In step 614, HMS 108 then checks if there is any member liability or not. If not, process 600 ends in step 624. If there is a member liability pending, HMS 108 pays provider 102 for member liability in step 616. Provider 102 then receives member liability in step 618 from HIS 108. Further to step 616, HMS 108 then bills member P for payment made to provider 102 in step 620. Member P is covered by an external insurance plan, like BlueCross. Member P may or may not have any prior relationship with HMS 108 or an associated financial institution related to HMS 108. Process 600 ends with member P paying HMS 108 for member liability, as shown in step 622.

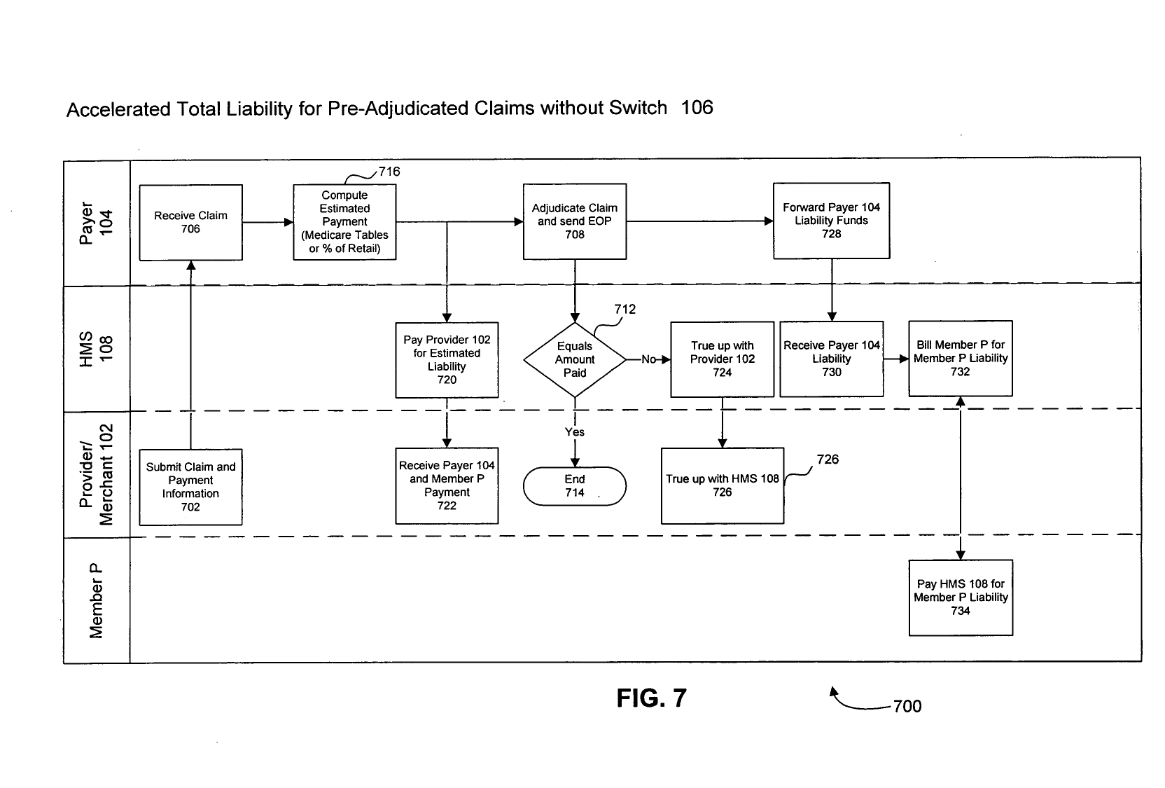

FIG. 7 illustrates a process 700 involving HMS 108 ( which may be associated with a financial institution 109, for example) and payer 104. L1 step 702, provider 102 submits claim and payment information to payer 104. Payer 104 receives the claim information in step 706. In step 716, payer 104 computes an estimate of payment for the submitted claim based on, for example, Medicare tables or percentage of retail. This information is then forwarded to HMS 108. HMS 108 pays provider 102 for the claim based on at least a percentage of the computed estimate, as shown in step 720. In step 722, provider 102 receives payment for patient P (or member P) and payer 104 liabilities based on the computed estimate.

Payer 104, in parallel, adjudicates the claim and sends an Explanation of payment (EOP) to HMS 108, in step 708. In step 712, financial institution 109 checks or compares whether or not the adjudicated claim amount and the estimated claim amount are equal. If yes, HMS 108 intimates provider 102 about completion of the claims process. If not, HMS 108 accordingly reconciles with provider 102, as shown in steps 724 and 726.

Alternatively or additionally, payer 104 forwards its own liability (shown in steps 728 and 730) to HMS 108. HMS 108 then bills member P for member P's liability, as shown in step 732. Finally, in step 734, member P pays HMS 108 for its own liability.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention (e.g., packaging and activation of other transaction cards and/or use of batch activation processes). Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1-7. (canceled)

8. A method for accelerating a payment to a provider for a healthcare related claim, comprising:
(a) receiving the healthcare related claim for payment submitted by the provider;
(b) determining an estimated total amount of liability for the healthcare related claim;
(c) paying at least a portion of the estimated total amount of liability for the healthcare related claim to the provider by a financial institution; and
(d) receiving at the financial institution a reimbursement from a funding source for the estimated total amount of liability for the healthcare related claim.

9. The method of claim 8, wherein the healthcare related claim is submitted by the provider to a payer; and further comprising:
(e) determining at the payer whether the healthcare related claim is eligible for the payment.

10. The method of claim 8, wherein step (a) further comprises:
receiving the healthcare related claim in at least one of a real time and a batch mode.

11. The method of claim 8, further comprising:
(e) receiving the healthcare related claim for an item received by a patient at a payer from a Switch.

12. The method of claim 11, further comprising performing an eligibility check by the Switch, prior to step (b).

13. The method of claim 8, further comprising:
(e) computing an actual amount to be paid to the provider based on at least one of Medicare tables, a percentage of retail and history data of the provider.

14. The method of claim 8, wherein step (c) further comprises:
receiving at the financial institution an estimate of respective payer and patient liabilities for the claim from a Switch; and
paying a percentage of the estimated payer and/or patient liabilities for the healthcare related claim to the provider.

15. The method of claim 8, further comprising:
(f) receiving an Explanation of Payment (EOP) at a healthcare management system.

16. The method of claim 15 further comprising receiving the EOP from a payer via a Switch.

17. The method of claim 15, further comprising:
(g) receiving a second payment for at least one of the patient's liability and the payer's liability.

18. The method of claim 8, wherein step (c) comprises:
depositing the portion of the estimated amount of liability for the healthcare related claim into an account held by the provider at the financial institution.

19. A method for accelerating a payment to a provider for a healthcare related claim, comprising:
(a) a financial institution receiving at least one of (i) a first estimate of a patient liability for the healthcare related claim and (ii) a second estimate of a payer liability for the healthcare related claim; and
(b) the financial institution paying the provider at least a portion of an amount corresponding to a sum of the first and the second estimates of the patient and the payer liability, respectively.

20. The method of claim 19, further comprising:
(c) billing the patient and the payer for respective liabilities; and
(d) receiving reimbursement from at least one of the payer and the patient for the payment of the healthcare related claim to the provider.

21. The method of claim 19 further comprising:
(c) the financial institution reconciling with the provider for an under or an over-payment made by comparing the sum to an actual amount to be paid to the provider for the healthcare related claim.

22. The method of claim 19, wherein step (a) comprises receiving the first and second estimates from at least one of the payer and a Switch.

23. The method of claim 22, further comprising sending an acknowledgement about the payment related to the healthcare related claim to the payer.

24. A method for accelerating payment to a provider for a healthcare related claim, comprising:
a financial institution receiving a negotiated estimate of at least one of patient and payer liabilities from a third party negotiator when the patient is an out of network patient;
the financial institution paying the provider for at least a portion of the negotiated estimate of the patient and payer liabilities; and
the financial institution receiving reimbursement from at least one of the payer and the patient for the negotiated estimate.

25. The method of claim 24, further comprising:
the financial institution reconciling with the provider for an under or an over-payment made by comparing the negotiated estimate to an actual amount from the third party negotiator to be paid to the provider for the healthcare related claim.

26. A method for accelerating payment for a healthcare related purchase, comprising:
a financial institution receiving at least one of (i) an estimate of a payer's liability for the healthcare related purchase, computed by the payer and (ii) an estimate of a patient's liability, computed by the payer;
the financial institution paying at least a portion of the estimate of the payer's liability and the estimate of the patient's liability to a provider; and
the financial institution comparing whether or not the portion of the estimate paid to the provider matches an adjudicated amount computed by the payer and accordingly reconciling with the provider.

27. A method for accelerating a payment to a provider for a healthcare related claim, comprising:
(a) a healthcare management system (HMS) receiving at least one of (i) a first estimate of a payer liability for the healthcare related claim and (ii) a second estimate of a patient liability for the healthcare related claim; and
(b) the HMS instructing a financial institution to pay the provider at least a portion of an amount corresponding to at least the first estimate of the payer liability.

28. The method of claim 27, wherein step (b) further comprises:
the HMS instructing the financial institution to pay the provider an amount corresponding to a sum of the first and the second estimates of the payer and the patient liability.

29. The method of claim 28, further comprising:
(c) billing the patient and the payer for respective liabilities; and
(d) the financial institution receiving reimbursement from at least one of the payer and the patient for the payment of the healthcare related claim to the provider.

30. The method of claim 28 further comprising:
(c) the HMS reconciling with the provider for an under or over-payment made by comparing the sum to an actual amount to be paid to the provider for the healthcare related claim.

31. The method of claim 28, wherein step (a) comprises receiving the first and second estimates from at least one of the payer and a Switch.

32. The method of claim 28, further comprising:
(c) sending an acknowledgement about the payment related to the healthcare related claim to the payer.
